(19) United States
(12) Patent Application Publication
(10) Pub. No.: US 2003/0212605 A1
(43) Pub. Date: Nov. 13, 2003

(54) Subscription-fee-based automated machine translation system

(75) Inventors: Jeffrey J. Chin, Sugar Land, TX (US); Rina Horiuchi, Old Greenwich, CT (US); Kevin Akira Lee, Cerritos, CA (US); David Lowsky, San Francisco, CA (US); Joshua D. Schroeder, San Francisco, CA (US); Christopher S. Hong, Potomac, MD (US); Nicholas Lee, Morris Plains, NJ (US); Shozo Fujiwara, Tokyo (JP); Kentaro Takeda, Tokyo (JP)

Correspondence Address: Fabio E. Marino, Bingham McCutchen LLP, Suite 1800, Three Embarcadero Center, San Francisco, CA, 94111, US

(73) Assignee: Amikai, Inc.

(21) Appl. No.: 10/142,365

(22) Filed: May 8, 2002

(51) Int. Cl. G06F 17/60

(52) U.S. Cl. 705/26

(57) ABSTRACT

A system and method for machine translation are provided by a downloadable free client computer program executable by the user's computer and a machine translation service, executable by remote servers located across a distributed computer network (e.g. the Internet), that is accessed on a subscription fee basis. In this way, the machine translation service provider is able to differentiate users and price and sell services accordingly.

### BACKGROUND OF THE INVENTION

1. Field of the Invention

The present invention relates generally to computer systems and, particularly, to automated translation systems.

2. Related Art

Current on-line human language translation services allow users to execute translations on remote servers over the Internet. The user initiates a translation request through some action through an interface on a local process, most typically a mouse-click on a web page in a web browser. The text to be translated is then transferred over the distributed computer network to the remote servers where the translation is executed, and the resultant translated text is communicated back across the computer network to the user's local machine.

These remote translation services calls, however, are executed in unauthenticated environments, so the individual user cannot be tracked or charged for the service. As a result, the company providing the service derives a revenue stream only from increased user loyalty, advertising, or the sale of downloadable software. The recent “burst of the Internet bubble” has shown the limited viability of this business model. Since the providing company is not able to charge for translation requests, the translation services provided free of charge are limited, depriving the user of access to more developed or expensive technologies that would not be cost-effective to provide free of charge.

More complex translation technology tools are currently made available on-line in the form of downloadable software. In these services, the user initiates a purchase transaction across the Internet. In return for the payment, the user is able to download and install a human language machine translation package on the user's computer. This package is run on the user's local machine, and all translations are executed on the local machine.

While the purchase transaction is made in an authenticated, secure environment, the language translations are executed on the user's local machine. Thus the price of the translation software is a flat fee that does not take into account how many or how few translations the user actually executes. As a result, the company providing the software cannot price-differentiate between heavy and light users, and users are forced to invest a significant amount of money up-front, regardless of the level of their use of the actual translation software product.

### SUMMARY OF THE INVENTION

The system and method of the present invention overcome the limitations of prior art systems by providing a downloadable free client computer program executable by the user's computer and a machine translation service, executable by remote servers located across a distributed computer network (e.g. the Internet), that is accessed on a subscription fee basis.

In some embodiments of the invention, the company providing the human language machine translation software employs a billing service—optionally one or multiple 3^{rd} party entities—to control a user's account. The user purchases access to the machine translation service using the billing service. When the user wants to begin sending translation requests, he or she signs in, and the translation service provider checks with the appropriate billing provider to authenticate the user's account. A Session ID is generated and stored in a Session database with the translation service provider, and the Session ID is also communicated back across the distributed computer network to the user's client computer. Now when the user initiates a translation request, the client computer program submits both the text to be translated along with the Session ID. The machine translation service provider then checks the Session ID against the local Session database to authenticate the user and the translation request. The Session ID is temporary and expires after a fixed period of time or when another login request is made using the same user account.

In this way, the machine translation service provider is able to differentiate users and price and sell services accordingly. The machine translation service provider can optionally work with multiple 3^{rd} party billing providers. Through the use of the Session ID and the Session database (which authenticates only once per session instead of at each translation request), the machine translation service provider can bar multiple users from using the same account simultaneously. In addition, communication traffic with the billing service is substantially reduced and the speed of individual translation requests is increased.

From the user's standpoint, the use of a billing service to authenticate translation sessions allows the user to gain access to the machine translation services that could not feasibly be offered for free. Additionally, the ability to pay for service without being forced to purchase the actual software allows the user to gain access to more complex translation technology without being forced to make a significant initial investment. The use of the Session ID and Session database obviates the need for sign-in and password submission with each translation. Signing in once per session creates a faster and more convenient process when submitting individual translation requests.

### BRIEF DESCRIPTION OF THE DRAWINGS

FIG. 1 is a block diagram illustrating the overall architecture of a computer system, in accordance with some illustrative embodiments of the invention.

FIG. 2 is a block diagram illustrating the architecture of a computer system for downloading the client computer program, in accordance with some illustrative embodiments of the invention.

FIG. 3 is a flow diagram describing the process of downloading the client computer program of FIG. 2.

FIG. 4 is a block diagram illustrating the architecture of a computer system through which a user signs-up for an account on a server-based machine translation service, in accordance with some illustrative embodiments of the invention.

FIG. 5 is a flow diagram describing the process through which a user signs-up for an account on the server-based machine translation service of FIG. 4.

FIG. 6 is a block diagram of the architecture of a computer system through which a user signs-in to use a server-based machine translation service, in accordance with some illustrative embodiments of the invention.

FIG. 7 is a flow diagram describing the process through which a user signs-in to use the server-based machine translation service of FIG. 6.

FIG. 8 is a block diagram of the architecture of a computer system through which a user performs a translation using a server-based machine translation service, in accordance with some illustrative embodiments of the invention.

FIG. 9 is a flow diagram describing the process through which a user performs a translation using the server-based machine translation service of FIG. 8.

FIG. 10 is a block diagram illustrating the overall architecture of a computer system in which a text adapter prepares text output from an application or device for safe transmission, in accordance with some illustrative embodiments of the invention.

FIG. 11 is a flow diagram of the process through which the text adapter of FIG. 10 prepares text output from an application or device for safe transmission.

FIG. 12 is a flow diagram of the process through which a text adapter prepares text input received by an application or device for proper processing by the application or device, in accordance with some illustrative embodiments of the invention.

FIG. 13 is a screenshot showing a destination translation window, in accordance with some illustrative embodiments of the invention.

FIG. 14 is a screenshot showing a translation job queue window, in accordance with some illustrative embodiments of the invention.

FIG. 15 is a screenshot showing how a user can choose the destination of the translation of an incoming email message, in accordance with some illustrative embodiments of the invention.

FIG. 16 is a screenshot showing how a user can select whether to display an original email alone or the original and translation together, in accordance with some illustrative embodiments of the invention.

FIG. 17 is a screenshot showing how a user can choose the destination of the translation of an outgoing email message, in accordance with some illustrative embodiments of the invention.

### DETAILED DESCRIPTION OF THE INVENTION

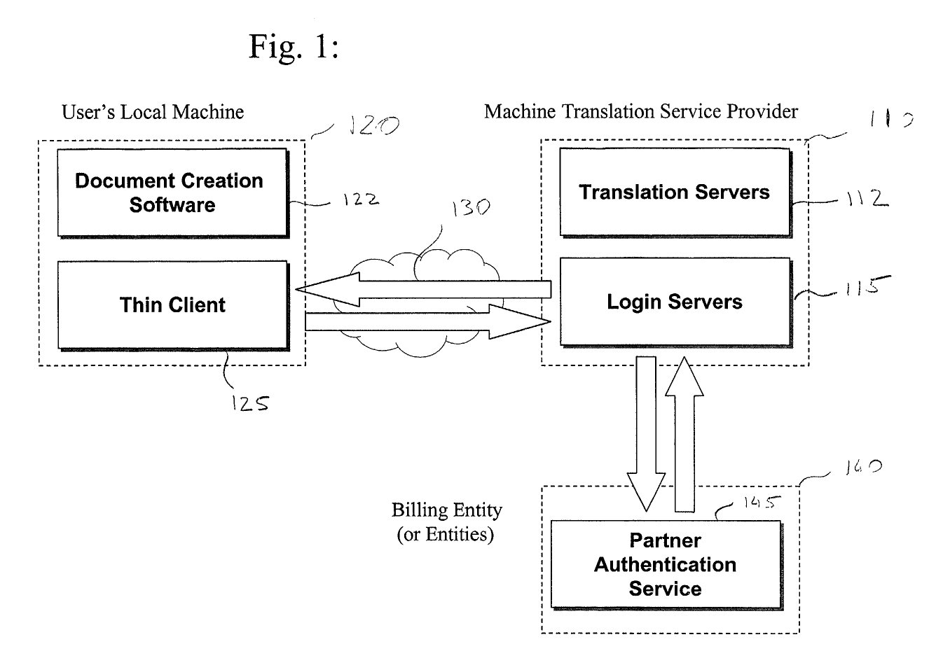

FIG. 1 is a block diagram of the overall architecture of a server-based machine translation service, in accordance with some illustrative embodiments of the invention. A server 110 is connected to one or more client computers 120 via a distributed network 130. On client computer 120 reside one or many document creation software applications 122 and a client computer program 125. In some embodiments of the invention, client computer program 125 is thin (i.e. it requires very little storage space), so that the client computer program 125 can be quickly downloaded onto client computer 120 over distributed computer network 130. Examples of document creation software applications 122 include word processing, email, spreadsheet, or slide presentation software. In some embodiments, client computer program 125 acts as a plug-in to one or more document creation software applications 122, to enable communication of translation requests with the machine translation service's servers 110. In some embodiments, however, client computer program 125 may also operate independently from document creation software applications 122.

Servers 110, in turn, contain machine translation servers 112 and log-in servers 115. Log-in servers 115 handle user account creation and sign-in authentication, communicating with Billing Services and with internal databases. Machine translation servers 112 process machine translation requests submitted by client computer programs 125 on user' client computers 120, and return the translated results to the requesting client computer program 125. Machine translation servers 112 can be any machine translation server known in the art, suitable for use in the present invention. A list of machine translation server providers in provided in Appendix A.

Billing services 145 are optionally internal to the server-based machine translation service provider (not shown), or are 3^{rd} party partners 140 (as shown in FIG. 1).

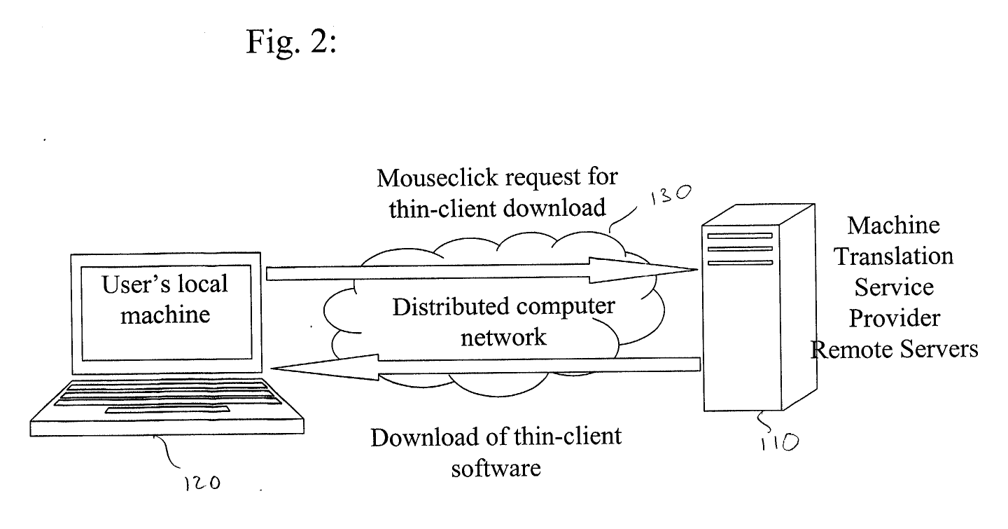

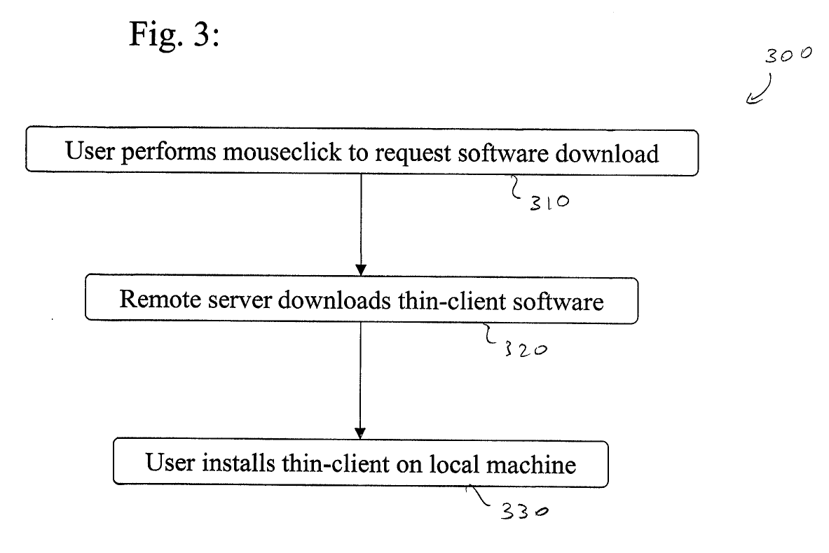

FIGS. 2 and 3 are block and flow diagrams describing a process 300 through which a user downloads the client computer program 125. Initially (stage 310), the user submits a request for client computer program 125 to be downloaded across distributed computer network 130 (e.g. the Internet). In some illustrative embodiments of the invention, this request could take the form of a mouse click in a web browser on a web page offering the client computer program download. Servers 110 receive the request, and immediately (stage 320) begin download of client computer program 125. Since client computer program 125 is provided for free (or for a nominal fee) to the user, there is no need to exchange billing or account information. Downloaded client computer program 125 is then installed on the user's client computer 120 (stage 330).

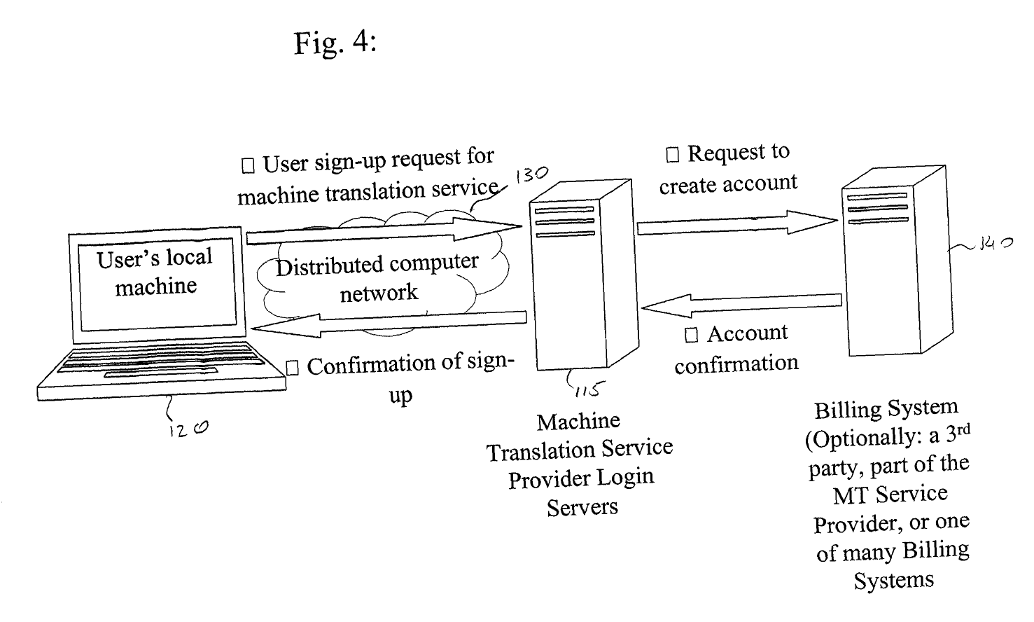

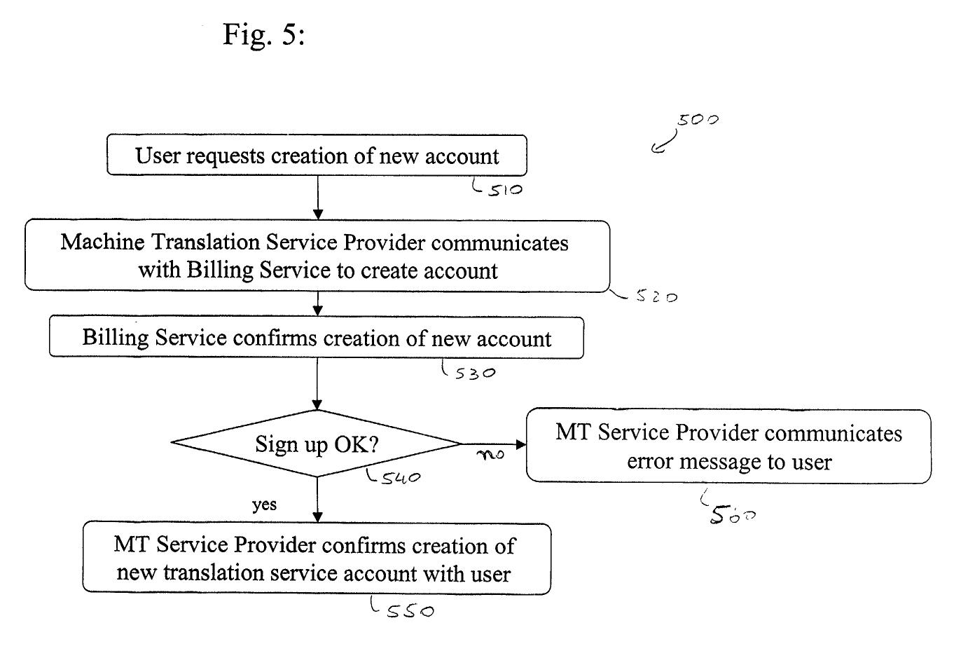

FIGS. 4 and 5 are block and flow diagrams describing a process 500 through which a user signs up for a server-based machine translation service, in accordance with some exemplary embodiments of the invention. Initially (stage 510) the user submits a request for account creation across distributed computer network 130. This request may involve a multi-part process including submission of information such as preferred account name, preferred account password, payment information, or other personal information. Login servers 115 transmit some or all of this information with billing service 140 (stage 520) to complete the account creation transaction (stage 530), including accepting payment and establishing the user account. If billing service 140 is able to create an account for the user (stage 540), login servers 115 are notified so that they may confirm the success of the account creation to the user's client computer 120 (stage 550). Conversely, if billing service 140 is unable to create an account for the user (stage 540), login servers 115 are notified so that they may inform the user through a error message to the user's client computer 120 (stage 560).

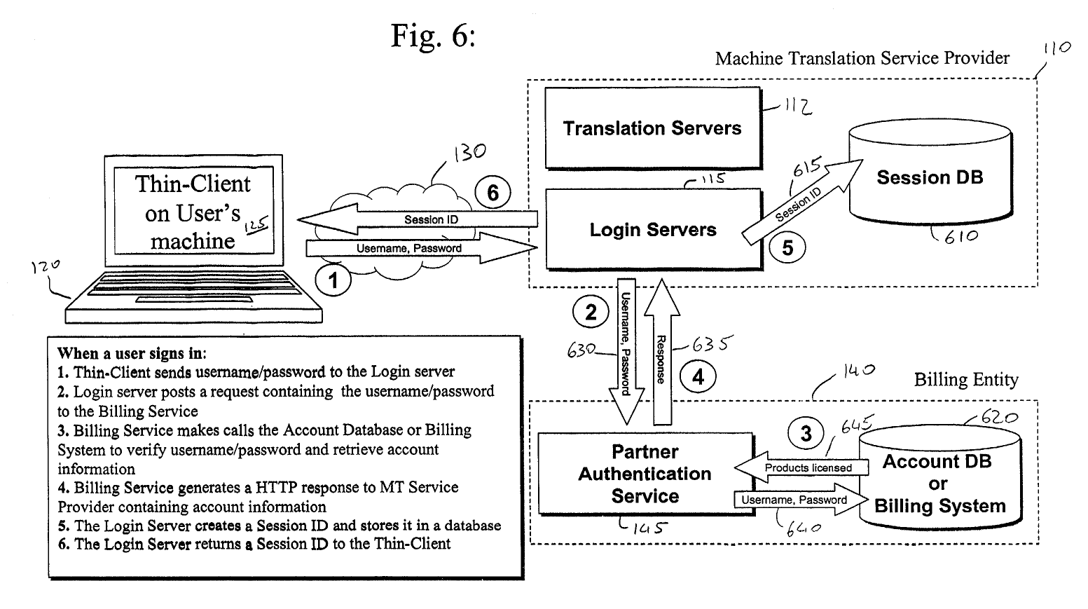

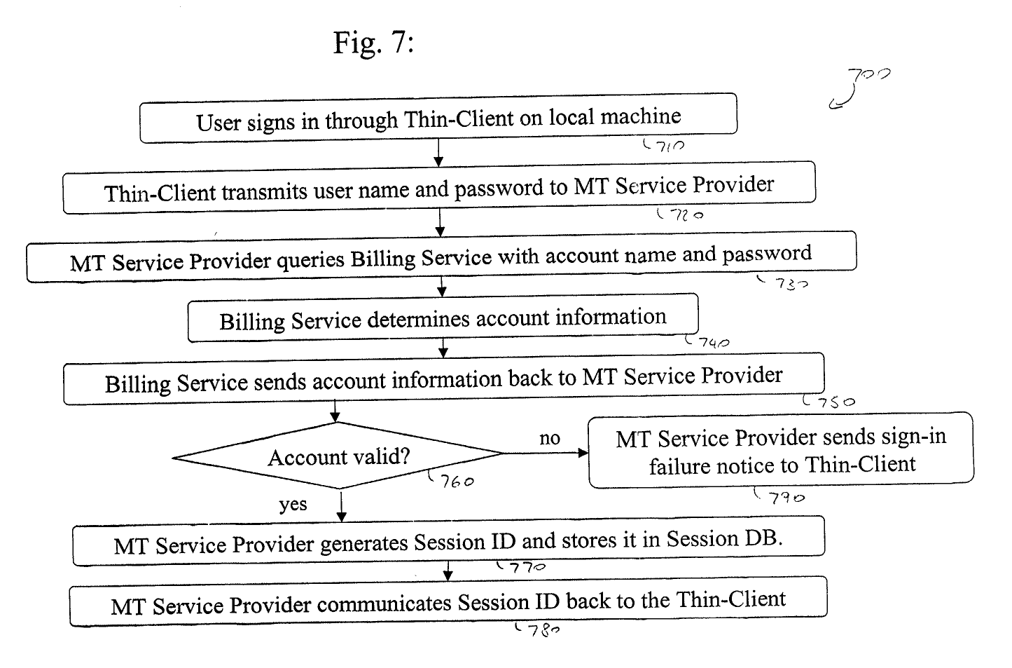

FIGS. 6 and 7 describe a process 700 through which a user signs-in to use the ASP-based Machine Translation Service, in accordance to some exemplary embodiments of the invention. The user initiates the sign-in process through the interface of the client computer program 125 on the user's client computer 120 (stage 710). Client computer program 125, in turn, transmits the user's account information (stage 720), such as account name and password across distributed computer network 130 to login servers 115 on servers 110. Login servers 115 then query billing service 140 with the user's account information 630 (stage 730). Billing service 140 authenticates the account information (stage 740) and communicates an account status 635 back to login servers 115 (stage 750). Billing service 140, in fact, uses partner authentication service 145 to query account database 620 with the user name and password 640 and obtain a response 645. If the account information is not valid (stage 760), login servers 115 communicate this error message back to the client computer program 125 on the user's client computer 120 (stage 790). Conversely, if the account information is valid (stage 760), login servers 115 are notified and a session ID 615 is generated (stage 770), stored in a session database 610, and then transmitted back to client computer program 125 on the user's client computer 120 where it is stored (stage 780).

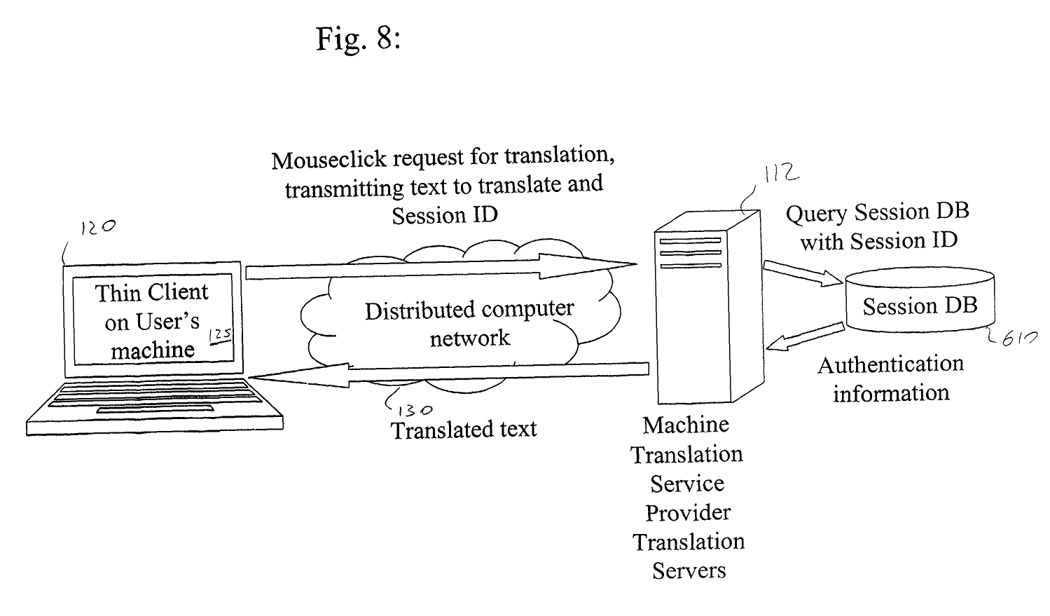

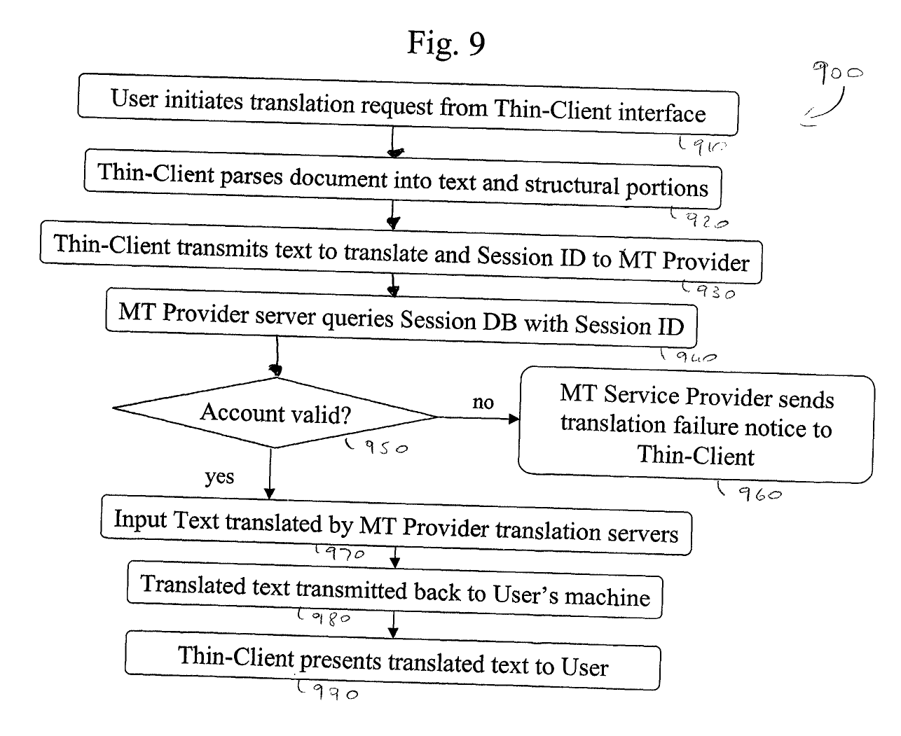

FIGS. 8 and 9 describe a process 900 through which a user submits a translation request to the server-based machine translation service, in accordance with some exemplary embodiments of the invention. The user initiates a translation request (stage 910) either through client computer program 125 running as a plug-in to a content creation software application 122 or through client computer program 125 itself. As discussed in reference to FIG. 1, document creation software 122 can be word processing, email, spreadsheet, slide presentation, or other document creation software. After the initiation of the translation request, client computer program 125 parses the text to translate from the document structure and saves the structural information about the document (stage 920). The plain-text is then communicated along with session ID 615 across distributed computer network 130 to the one or more translation servers 112 on servers 110 (stage 930). Session ID 615 is checked against the information stored in session database 610 (stage 940). If session ID 615 is not valid (stage 950), the failure is reported back to the client computer program 125 on the user's client computer 120 (stage 960). Conversely, if session ID 615 is valid (stage 950), translation servers 122 translate the submitted text (stage 970), and return the translated output text to client computer program 125 on the user's client computer 120 (stage 980). Client computer program 125 then reassembles the translated text into the saved document structure to create a translated version of the original, richly-structured document (stage 990).

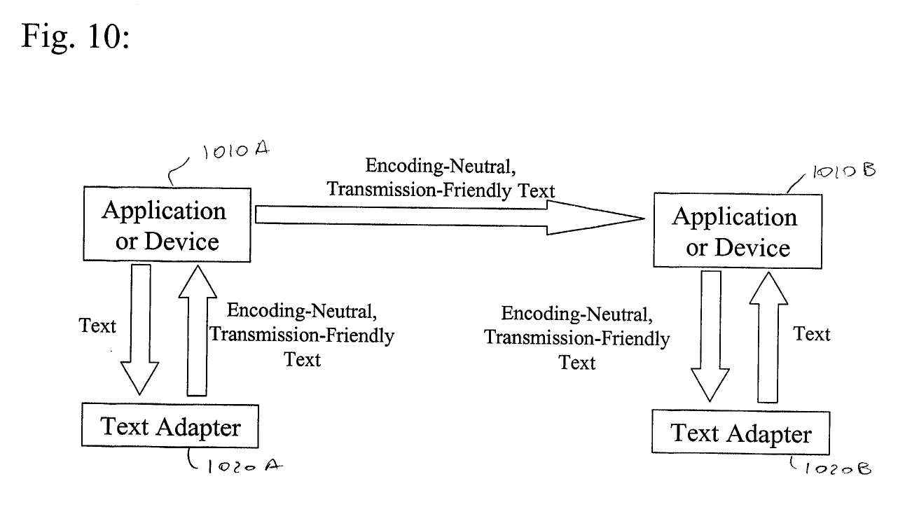

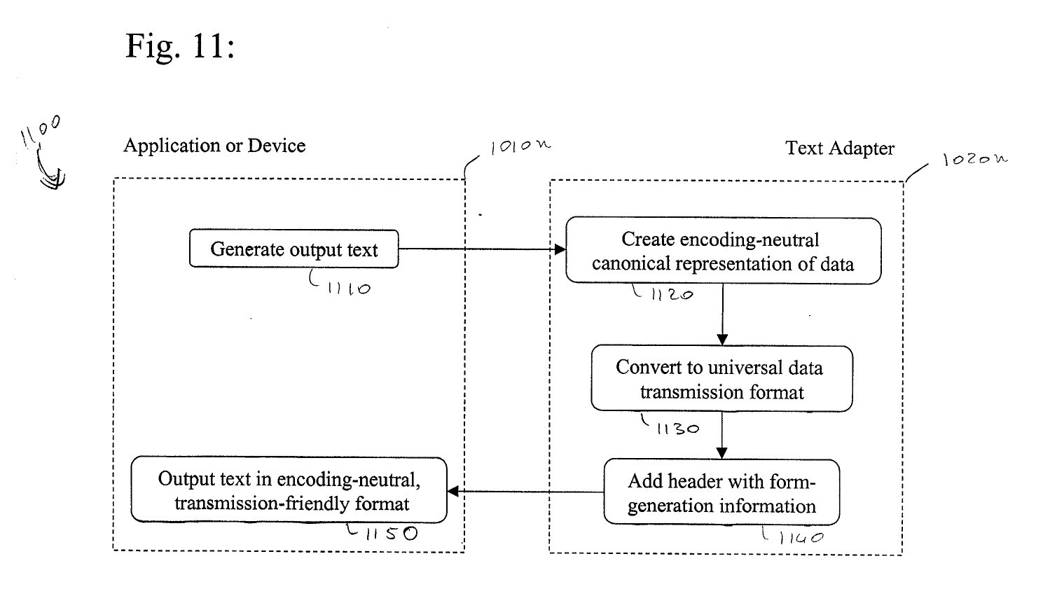

FIGS. 10 and 11 describe how client computer program 125 correctly handles and manipulates text data regardless of the limitations imposed by the operating system or by the document-creation software. This processing is necessary because computer systems and applications impose certain limitations on the types of text data which they are capable of handling. A machine translation system, however, must be prepared to handle many different character sets and provide text encoding flexibly. This is accomplished via specialized text data adapters 1020n (where n=A, B, C . . . ), which are used for all transmission (both synchronous and asynchronous) of text between applications 1010n and devices 1010n, applications 1010n and applications 1010n, and devices 1010n and devices 1010n. Text data adapters 1020n re-encode the text data in a platform-independent manner and transmit that re-encoded information as a protected canonical data type. FIG. 10 shows the overall architecture of this system.

FIG. 11 describes a process 1100 through which a text adapter 1020n prepares text output from an application 1010n or device 1010n for safe transmission, regardless of the encoding limitations of the operating system or receiving application or device. First, the transmitting application or device sends a request to text adapter 1020n (stage 1110), where the request consists of the original text data and the name or ID of the encoding used in the original text data. The request may also specify the canonical form convention that text adapter 1020n should use to generate the output data.

Text adapter 1020n creates an encoding-neutral canonical representation of the original text data (stage 1120) by first converting the text data to a base universal encoding, such as UTF-16 or any other base universal encoding. Then the encoding-neutral canonical representation is converted to a universal data transmission format (stage 1130), such as ASCII, using a general binary-to-transmission-format encoding scheme, such as base-64 encoding. This transmission-friendly form of the encoding-neutral representation is then prefixed with a header that indicates the form used to generate the data (stage 1140). The text adapter then returns this header-prefixed data to the transmitting application 1010n or device 1010n (stage 1150), which can then safely transmit then data.

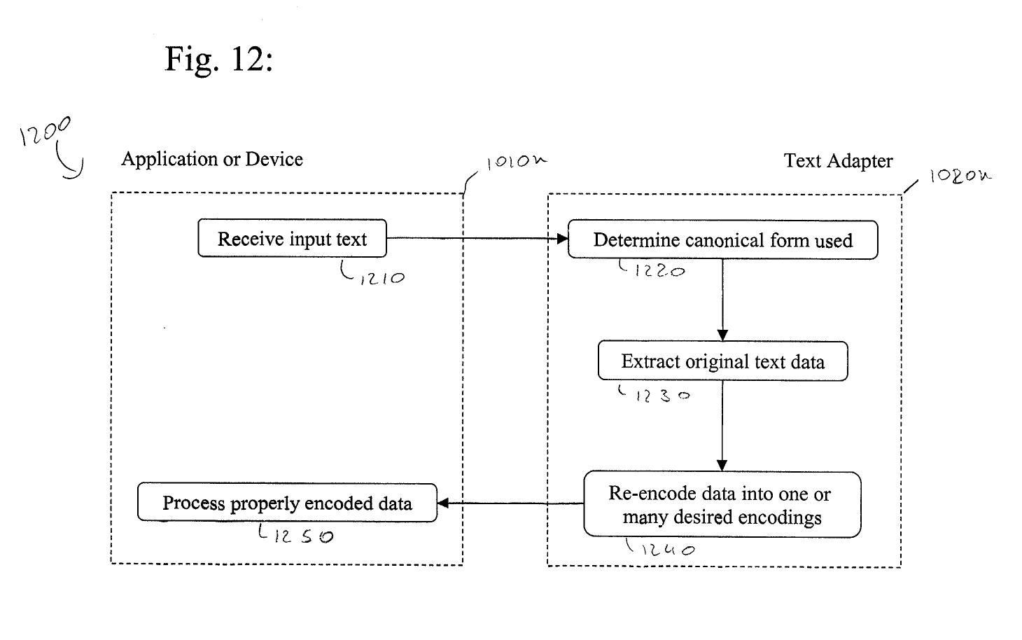

FIG. 12 describes a process 1200 through which a text adapter 1020n prepares text input received by an application 1010n or device 1010n for proper processing by the application 1010n or device 1010n, regardless of the encoding limitations of the operating system, application, or device, and without losing any information about the original text. First, the receiving application 1010n or device 1010n receives some text input in an encoding-neutral, transmission-friendly format (stage 1210). Application/device 1010n, in turn, sends a request to text adapter 1020n, where the request consists of the canonical representation of the text data and the one or many desired text character encoding for the text. Upon receipt, text adapter 1020n examines the canonical representation and determines the canonical form used (stage 1220). Text adapter 1020n then extracts the original text data (in the base universal text encoding) using that information (stage 1230). Text adapter 1020n, in turn, re-encodes the extracted text data into one of the target text encoding specified in the request and returns that re-encoded data to the host application (stage 1240). The re-encoded data can then be processed by application/device 1010n (stage 1250).

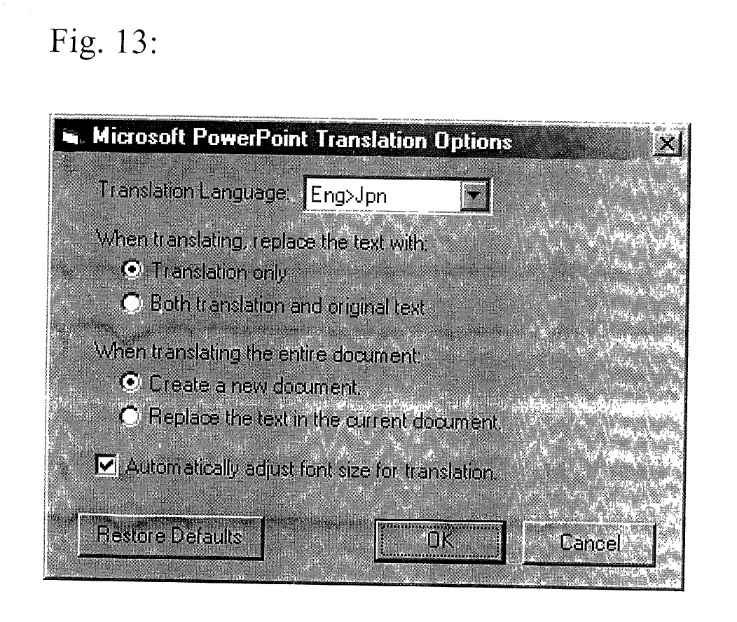

FIG. 13 is a screenshot of a translation destination window 1300, in accordance with some illustrative embodiments of the invention. By selecting options listed on translation destination window 1300, the user is able to select the destination of the translation result of a translation request. During the translation process, the user is queried for a translation destination, and the system sends the translation to the appropriate destination. Possible translation destinations include the end of the original source text document, the clipboard, a new document, or an attachment to a document.

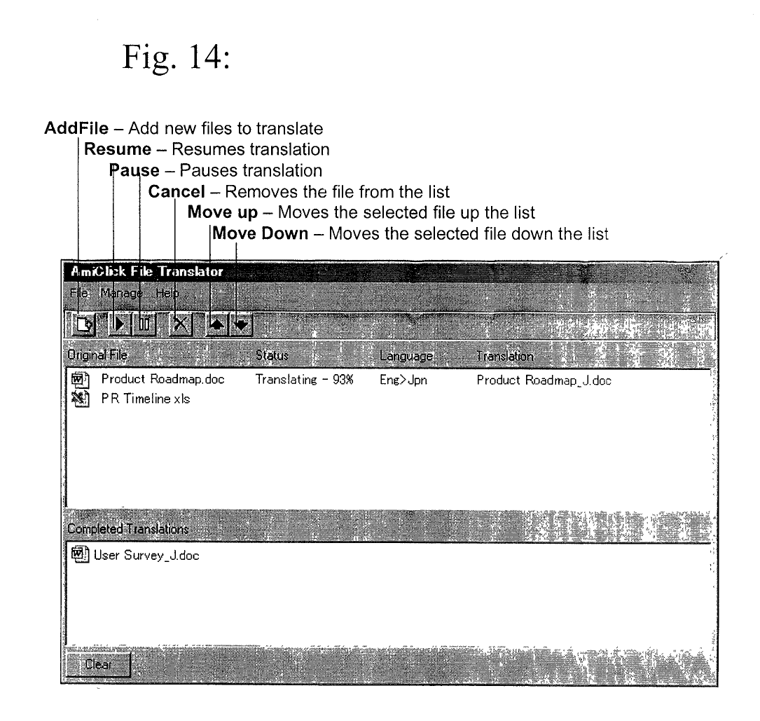

FIG. 14 is a screenshot of a translation job queue window 1400, in accordance with some illustrative embodiments of the invention. Translation job queue window 1400 shows the printing queue for a user using the translation service. When a translation request is made, the document enters the queue at an appropriate location. When the translation service is ready to service a request, it pulls a document from the queue from an appropriate location. When a document translation is completed, the document is either returned to the queue, marked as completed, or is returned to a separate list of completed translations. While a document is queued, the user can use the queue to raise or lower the priority of the document's translation. While a document is being translated, the user can use the queue to suspend the document's translation and reinsert the document into the queue. After a document translation has been completed, a user can use the queue or the completed translation list to request that the document be opened with an appropriate application.

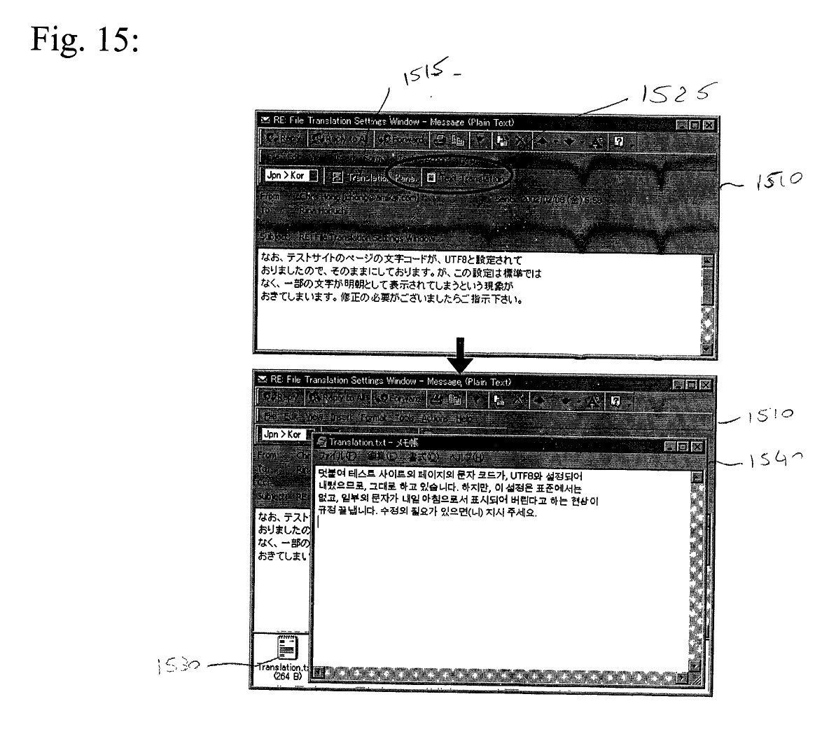

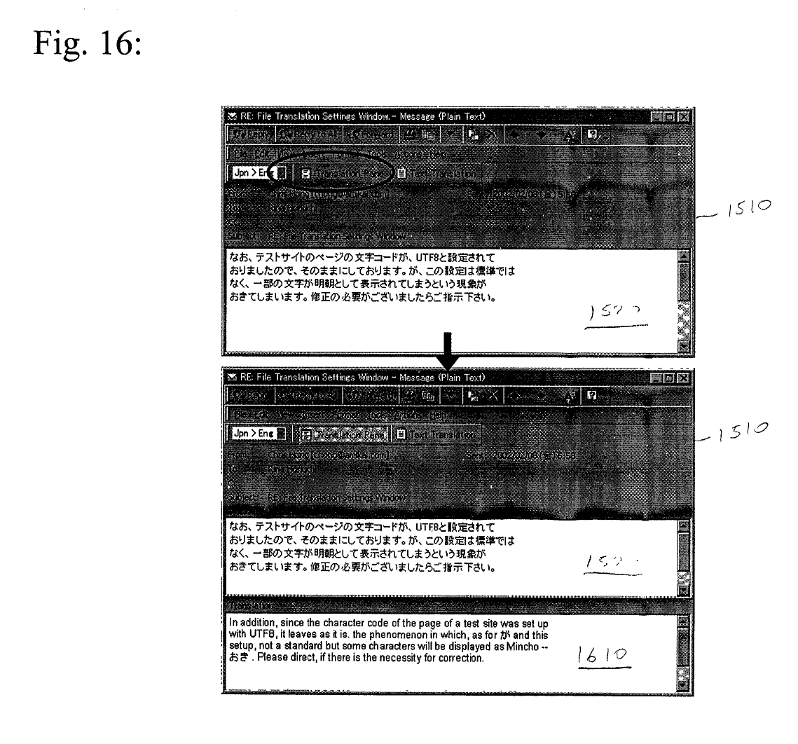

FIGS. 15-16 are screenshots illustrating elements of an email plug-in user interface for incoming messages, in accordance with some exemplary embodiments of the invention. In particular, FIG. 15 shows how the user can select the destination of the translation of an incoming email message via translation pane button 1515 and text translation button 1525. If the user selects text translation button (FIG. 15) the translation is stored as an attachment 1530 to the incoming message, which conveniently binds the original 1510 and translated versions 1540 of the email message. Conversely, FIG. 16 shows the user's ability to toggle the display between showing the original alone and the original with the translation by selecting translation pane button 1515. In some embodiments of the translation service, the user could also be allowed to display only the translation of the email message 1610.

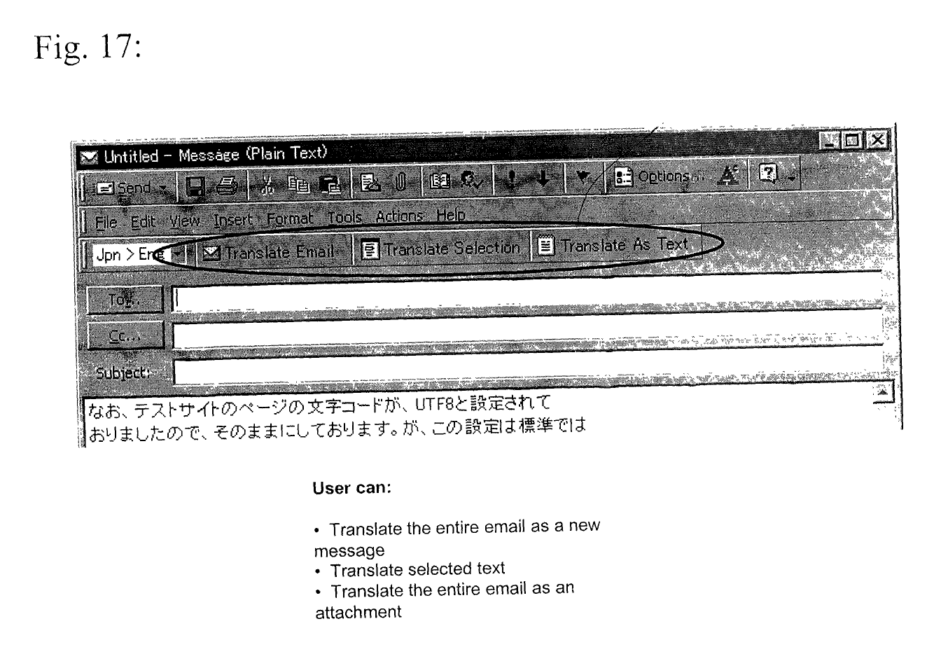

FIG. 17 shows the user's choices for the destination of the translation of an outgoing email message 1710. Exemplary translation destinations include a new email message, the end of the original message, or an attachment to the original message. The user is able to select among possible translation destination via buttons 1720.

Embodiments described above illustrate, but do not limit the invention. In particular, the invention is not limited to any specific hardware or software implementations. In fact, the system and method of the present invention can be implemented using any combination of hardware and/or software components, in accordance with the principles of the present invention. Other embodiments and varieties are within the scope of the invention, as defined by the following claims.

[image]

[image]

[image]

[image]

[image]

I claim:

1. A computer system comprising:
a server computer connected to one or more client computers via a distributed computer network; and
a server computer program executable by the server computer, the server computer program comprising computer instructions for:
downloading free of charge a client computer program to one of the client computers, in response to a request by the client computer; and
generating a translated document on a subscription-fee basis in response to a request from the client computer program.

2. The computer system of claim 1, wherein the distributed computer network is a global-area computer network.

3. The computer system of claim 2, wherein the global-area computer network is the Internet.

4. The computer system of claim 1, wherein the server computer program further comprises computer instructions for:
checking sign in information with a billing provider to authenticate a user account; and
if the user account is authenticated, generating a session ID stored in a session database and sending the session ID to the client computer program.

5. The computer system of claim 1, wherein the client computer program further comprises computer instructions for:
sending the session ID together with the request to translate the document to the server computer.

6. The computer system of claim 5, wherein the server computer program further comprises computer instructions for:
checking the session ID received from the client computer program against the session database to authenticate the translation request.

7. The computer system of claim 6, wherein the session ID expires after a fixed period of time or when another login request is made using the same sign in information.

8. The computer system of claim 1, wherein the client computer program is a plug-in.

9. The computer system of claim 1, wherein the client computer program downloaded onto the client computer is thin.

10. The computer system of claim 1, wherein the subscription fee is based on a number of translation requests made by a user.

11. A method of providing automated translation services, the method comprising:
downloading from a server computer free of charge a client computer program to a client computer connected to the server computer by a distributed computer network, in response to a request by the client computer; and
generating a translated document on a subscription-fee basis in response to a request from a client computer program executed by the client computer.

12. The method of claim 11, wherein the distributed computer network is a global-area computer network.

13. The method of claim 12, wherein the global-area computer network is the Internet.

14. The method of claim 11, further comprising:
checking sign in information with a billing provider to authenticate a user account; and
if the user account is authenticated, generating a session ID stored in a session database and sending the session ID to the client computer program.

15. The method of claim 11, further comprising:
receving the session ID together with the request to translate the document.

16. The method of claim 15, further comprising:
checking the session ID received from the client computer program against the session database to authenticate the translation request.

17. The method of claim 16, wherein the session ID expires after a fixed period of time or when another login request is made using the same sign in information.

18. The method of claim 11, wherein the client computer program is a plug-in.

19. The method of claim 11, wherein the client computer program downloaded onto the client computer is thin.

20. The method of claim 11, wherein the subscription fee is based on a number of translation requests made by a user.

21. A computer-readable storage medium storing a server computer program executable by a server computer connected to one or more client computers via a distributed computer network, the server computer program comprising computer instructions for:
downloading free of charge a client computer program to one of the client computers, in response to a request by the client computer; and
generating a translated document on a subscription-fee basis in response to a request from the client computer program.

22. The computer-readable storage medium of claim 21, wherein the distributed computer network is a global-area computer network.

23. The computer-readable storage medium of claim 22, wherein the global-area computer network is the Internet.

24. The computer-readable storage medium of claim 21, wherein the server computer program further comprises computer instructions for:
checking sign in information with a billing provider to authenticate a user account; and
if the user account is authenticated, generating a session ID stored in a session database and sending the session ID to the client computer program.

25. The computer-readable storage medium of claim 21, wherein the client computer program further comprises computer instructions for:
sending the session ID together with the request to translate the document to the server computer.

26. The computer-readable storage medium of claim 25, wherein the server computer program further comprises computer instructions for:
checking the session ID received from the client computer program against the session database to authenticate the translation request.

27. The computer-readable storage medium of claim 26, wherein the session ID expires after a fixed period of time or when another login request is made using the same sign in information.

28. The computer-readable storage medium of claim 21, wherein the client computer program is a plug-in.

29. The computer-readable storage medium of claim 21, wherein the client computer program downloaded onto the client computer is thin.

30. The computer-readable storage medium of claim 21, wherein the subscription fee is based on a number of translation requests made by a user.
